(19) United States
(12) Patent Application Publication
(10) Pub. No.: US 2012/0227317 A1
(43) Pub. Date: Sep. 13, 2012

(54) Plant Stand

(76) Inventor: Jui-Ju Yeh, Taipei (TW)

(21) Appl. No.: 13/044,675

(22) Filed: Mar. 10, 2011

(51) Int. Cl. A01G 9/12

(52) U.S. Cl. 47/39

(57) ABSTRACT

A plant stand has a seat, multiple support bars and a decorative piece. The seat has a mounting stem mounted on a top surface thereof and having threads formed around a periphery of the mounting stem. A top end of each support bar is mounted through the seat. A hook is formed between the top ends of two support bars and underneath the seat for hanging a potted plant. Each support bar has a foot formed on a bottom end thereof. The decorative piece is detachably mounted around the mounting stem. Accordingly, the decorative piece of the plant stand can be easily replaced to create a look and style desired by the landscape of a surrounding environment.

### BACKGROUND OF THE INVENTION

1. Field of the Invention

The present invention relates to a plant stand, and more particularly to a plant stand featuring easy replacement of decoration of the plant stand.

2. Description of the Related Art

Potted plants are common elements to indoor decoration and courtyard landscape design. To demonstrate potted plants more aesthetically and place potted plants more conveniently, plant stands are ideal when users come to mind to hang or place the potted plants. Oftentimes, proper plant stands need to be chosen in response to a style of a surrounding environment or the types of the placed potted plants.

When the placed potted plants are replaced or the style of the surrounding environment, such as courtyard or interior space, changes, the original plant stands need to be replaced with new ones for being consistent with the look or style of the replaced potted plants or the landscape of the new surrounding environment. However, in response to the above change, besides spending money to purchase new plant stands, it also takes time and effort to move the new plant stands to intended locations and relocate the potted plants from the old plant stands to the new plant stands.

### SUMMARY OF THE INVENTION

An objective of the present invention is to provide a plant stand featuring easy replacement of decoration of the plant stand.

To achieve the foregoing objective, the plant stand has a seat, multiple support bars and a decorative assembly.

The seat has a top surface, a bottom surface and a mounting stem. The mounting stem is formed on the top surface and has a periphery and threads. The threads are formed around the periphery of the mounting stem.

Each support bar has a top end, a bottom end and a foot. The top end is mounted through the seat. The foot is formed on and protrudes downwardly from the bottom end.

The decorative assembly has a threaded hole for the decorative assembly to be detachably mounted around the mounting stem of the seat.

Preferably, the plant stand further has a hook mounted between the top ends of two of the support bars and underneath the seat.

As the decorative assembly can be detachably mounted around the mounting stem of the seat, the original decorative assembly mounted around the mounting stem can be easily replaced with a desired decorative assembly matching the look and style of a new surrounding environment and a new potted plant hung by the hook without spending extra money, time and effort to replace the entire plant stand.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a plant stand in accordance with the present invention;

FIG. 2 is a partially enlarged perspective view of the plant stand in FIG. 1;

FIG. 3 is a partially enlarged exploded view of the plant stand in FIG. 1;

FIG. 4 is a partially enlarged front view in partial section of the plant stand in FIG. 1; and

FIG. 5 is another partially enlarged front view in partial section of the plant stand in FIG. 1.

### DETAILED DESCRIPTION OF THE INVENTION

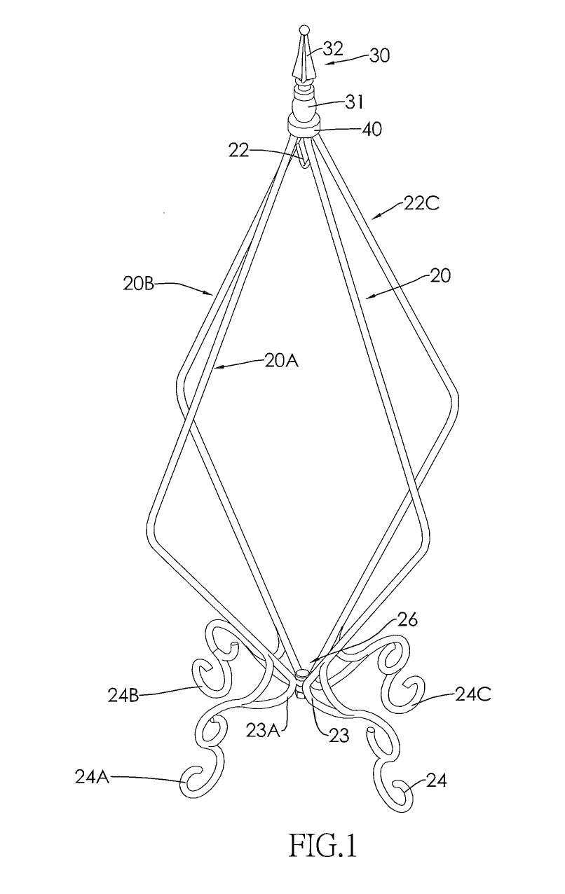

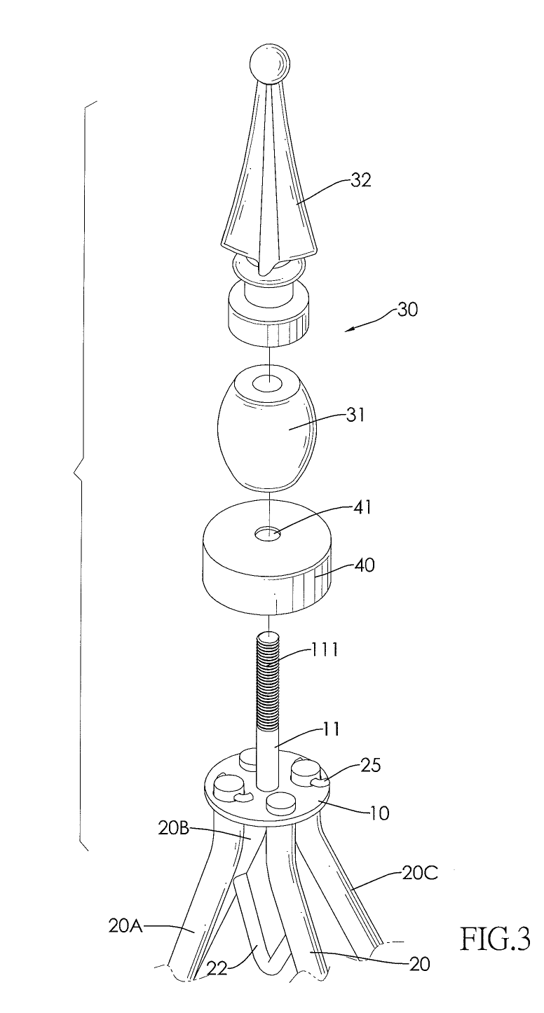

With reference to FIGS. 1 and 3, a plant stand in accordance with the present invention has a seat 10, multiple support bars 20, 20A, 20B, 20C, a hook 22, a pivoting member 26, a decorative assembly 30 and a cap 40.

The seat 10 has a mounting stem 11. The mounting stem 11 is formed on a top surface of the seat 10 and has threads 111 formed around a periphery of the mounting stem 11.

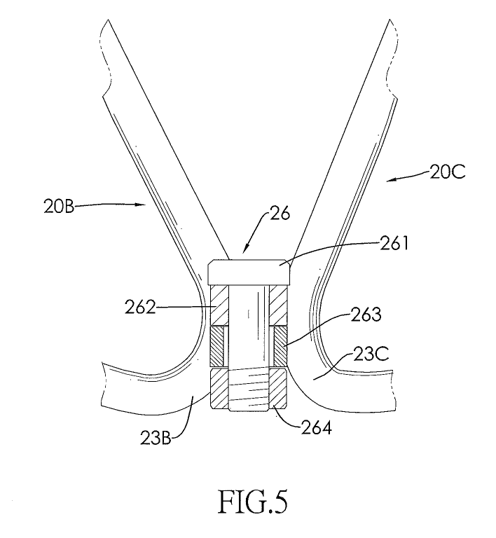

With reference to FIGS. 1, 3 and 5, each support bar 20, 20A, 20B, 20C has a junction portion 23, 23A, 23B, 23C and a foot 24, 24A, 24B, 24C. A top end of each support bar 20, 20A, 20B, 20C is mounted through the seat 10. A top end of each junction portion 23, 23A, 23B, 23C is integrally formed on a bottom end of one of the support bar 20, 20A, 20B, 20C. A top end of each foot 24, 24A, 24B, 24C is integrally formed on and protrudes downwardly from a bottom end of one of the junction portions 23, 23A, 23B, 23C. In the present embodiment, the plant stand is foldable and detachable. The top ends of opposite two of the support bars 20, 20B are securely mounted on the seat 10, and the hook 22 is mounted between the top ends of the two opposite support bars 20, 20B and underneath the seat 10. The top ends of another opposite two of the support bars 20A, 20C are pivotally mounted in the seat 10, and a pin 25 is mounted through each of the two opposite support bars 20A, 20C and on the top surface of the seat 10 so as to fix the two opposite support bars 20A, 20C on the seat 10.

The pivoting member 26 has a bolt 261, and a stationary ring 262, a rotary ring 263 and a nut 264 sequentially and downwardly mounted around the bolt 261. The stationary ring 262 is securely mounted around the bolt 261. The junction portions 23, 23B of two of the support bars 20, 20B are connected with the stationary ring 262. The rotary ring 263 is rotatably mounted around the bolt 261. The junction portions 23A, 23C of the other two of the support bars 23A, 23C are connected with the rotary ring 263. The nut 264 is mounted around a bottom end of the bolt 261. When the plant stand is folded, the two support bars 20A, 20C are rotated and respectively stacked on the other two support bars 20, 20B.

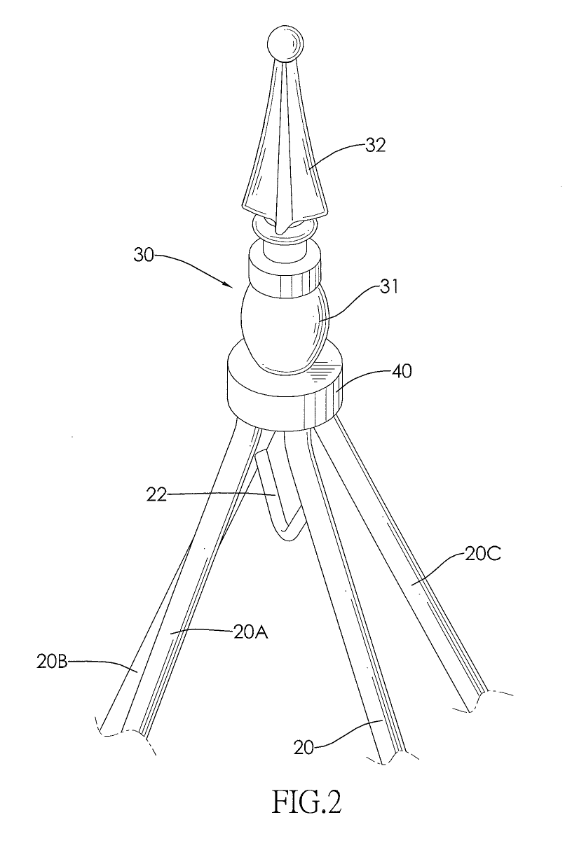

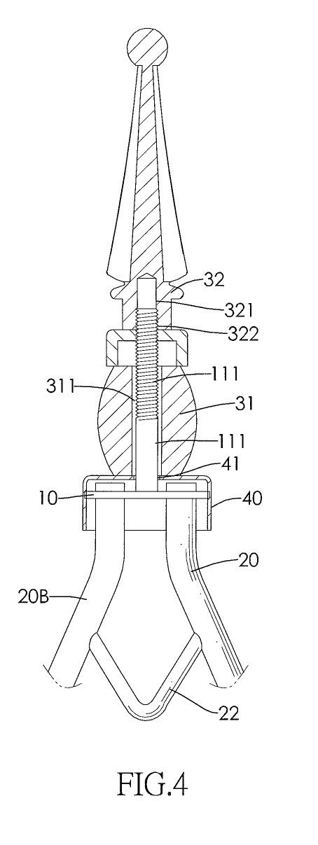

With reference to FIGS. 2 to 4, the decorative assembly 30 is detachably mounted around the mounting stem 11 of the seat 10. In the present embodiment, the decorative assembly 30 has a decorative sleeve 31 and a decorative top 32. The decorative sleeve 31 has a cavity 311 formed through the decorative sleeve 31 and mounted around the mounting stem 11 of the seat 10. The cavity 311 may be a threaded hole. The decorative top 32 has a blind hole 321 formed on and recessed inwardly from a bottom of the decorative top 32 and having threads 322 formed on an inner wall of the blind hole 321 to engage the threads 111 on the mounting stem 11. In an alternative embodiment of the decorative piece 30, the decorative piece 30 has only one decorative top 32 mounted on the seat 10.

The cap 40 is mounted to cover the top surface of the seat 10, and has a through hole 41 formed through the cap 40 for the mounting stem 11 of the seat 10 to penetrate through.

As the decorative assembly 30 can be detachably combined with the mounting stem 11 of the seat 10, if intending to replace the decorative assembly 30, the replacement can be easily achieved by removing the original decorative assembly from the mounting stem 11 and mounting another decorative assembly 30 around the mounting stem 11. Hence, the plant stand can easily adapt to the look and style of a new surrounding environment and a new type of potted plant without spending extra money, time and effort to replace the entire plant stand. Additionally, the decorative piece 30 can be varied with different festivals, holidays or seasons to increase the amenities of life. For example, the decorative piece 30 having a form of an angel is good for Christmas, and the decorative piece 30 having a form of a pumpkin is good for Halloween.

Even though numerous characteristics and advantages of the present invention have been set forth in the foregoing description, together with details of the structure and function of the invention, the disclosure is illustrative only. Changes may be made in detail, especially in matters of shape, size, and arrangement of parts within the principles of the invention to the full extent indicated by the broad general meaning of the terms in which the appended claims are expressed.

What is claimed is:

1. A plant stand comprising:
a seat having:
a top surface;
a bottom surface; and
a mounting stem formed on the top surface and having:
a periphery; and
threads formed around the periphery of the mounting stem;
multiple support bars, each having:
a top end mounted through the seat;
a bottom end; and
a foot formed on and protruding downwardly from the bottom end; and
a decorative assembly having a threaded hole for the decorative assembly to be detachably mounted around the mounting stem of the seat.

2. The plant stand as claimed in claim 1, further comprising a hook mounted between the top ends of two of the support bars and underneath the seat.

3. The plant stand as claimed in claim 2, further comprising a cap mounted to cover the top surface of the seat, wherein the mounting stem is mounted through the cap.

4. The plant stand as claimed in claim 3, comprising four support bars, wherein
the top ends of opposite two of the support bars are securely mounted on the seat,
the hook is mounted between the top ends of the two opposite support bars and underneath the seat, and
the top ends of another opposite two of the support bars are pivotally mounted in the seat, and a pin is mounted through each of the two opposite support bars and on the top surface of the seat.

5. The plant stand as claimed in claim 4, further comprising a pivoting member, wherein
each support bar further has a junction portion formed on the bottom end of the support bar,
the pivoting member has a bolt, and a stationary ring, a rotary ring and a nut sequentially and downwardly mounted around the bolt, the stationary ring is securely mounted around the bolt, the junction portions of two of the support bars are connected with the stationary ring, the rotary ring is rotatably mounted around the bolt, the junction portions of the other two of the support bars are connected with the rotary ring, and the nut is mounted around a bottom end of the bolt.

6. The plant stand as claimed in claim 1, wherein the decorative assembly further has a decorative sleeve and a decorative top.

7. The plant stand as claimed in claim 2, wherein the decorative assembly further has a decorative sleeve and a decorative top.

8. The plant stand as claimed in claim 3, wherein the decorative assembly further has a decorative sleeve and a decorative top.

9. The plant stand as claimed in claim 4, wherein the decorative assembly further has a decorative sleeve and a decorative top.

10. The plant stand as claimed in claim 5, wherein the decorative assembly further has a decorative sleeve and a decorative top.

11. The plant stand as claimed in claim 6, wherein
the decorative sleeve has a cavity formed through the decorative sleeve and mounted around the mounting stem of the seat, and
the decorative top has a blind hole formed on and recessed inwardly from a bottom of the decorative top and having:
an inner wall; and
threads formed on the inner wall of the blind hole to engage the threads on the mounting stem.

12. The plant stand as claimed in claim 7, wherein
the decorative sleeve has a cavity formed through the decorative sleeve and mounted around the mounting stem of the seat, and
the decorative top has a blind hole formed on and recessed inwardly from a bottom of the decorative top and having:
an inner wall; and
threads formed on the inner wall of the blind hole to engage the threads on the mounting stem.

13. The plant stand as claimed in claim 8, wherein
the decorative sleeve has a cavity formed through the decorative sleeve and mounted around the mounting stem of the seat, and
the decorative top has a blind hole formed on and recessed inwardly from a bottom of the decorative top and having:
an inner wall; and
threads formed on the inner wall of the blind hole to engage the threads on the mounting stem.

14. The plant stand as claimed in claim 9, wherein
the decorative sleeve has a cavity formed through the decorative sleeve and mounted around the mounting stem of the seat, and
the decorative top has a blind hole formed on and recessed inwardly from a bottom of the decorative top and having:
an inner wall; and
threads formed on the inner wall of the blind hole to engage the threads on the mounting stem.

15. The plant stand as claimed in claim 10, wherein
the decorative sleeve has a cavity formed through the decorative sleeve and mounted around the mounting stem of the seat, and
the decorative top has a blind hole formed on and recessed inwardly from a bottom of the decorative top and having:
an inner wall; and
threads formed on the inner wall of the blind hole to engage the threads on the mounting stem.
